(19) United States
(12) Patent Application Publication
(10) Pub. No.: US 2016/0036176 A1
(43) Pub. Date: Feb. 4, 2016

(54) CONNECTOR

(71) Applicant: ACES ELECTRONICS CO., LTD., Zhongli City (TW)

(72) Inventors: Nobukazu Kato, Fussa-shi (JP); Saeyong Shin, Yokohama-shi (JP)

(73) Assignee: ACES ELECTRONICS CO., LTD., Zhongli City (TW)

(21) Appl. No.: 14/802,579

(22) Filed: Jul. 17, 2015

(30) Foreign Application Priority Data
Aug. 1, 2014 (JP) 2014-157966

(51) Int. Cl. H01R 24/60

(52) U.S. Cl. CPC H01R 24/60; H01R 2107/00

(57) ABSTRACT

Provided is a connector including a case having an opposing surface facing external device and a flat plate-shaped contact built in the case. The case includes a first opening which is formed at the opposing surface and through which a contact point of the contact to be connected to a connection terminal of the external device protrudes from the opposing surface, a receiver configured to receive a connector for external connection, and a holder configured to hold the contact. The contact includes the contact point which is disposed in the first opening and which is to contact with the connection terminal of the external device, an elastic portion which is disposed in the case and which moves the contact point in a substantially perpendicular direction relative to the opposing surface, a contact portion which is disposed in the receiver and which is to contact with a connection terminal of the connector for external connection, a held portion which is formed between the elastic portion and the contact portion and which is held by the holder in the case, and a connection portion which is formed between the elastic portion and the contact portion and which connects between the contact point and the contact portion in the case.

### CROSS-REFERENCE TO RELATED APPLICATIONS

The following priority application is incorporated herein by reference in its entirety: Japanese Patent Application No. 2014-157966 filed on Aug. 1, 2014.

### TECHNICAL FIELD

The present invention relates to a connector to be connected to connection terminals of electronic device.

### BACKGROUND ART

A personal digital assistance cradle has been heretofore known, which includes a circuit board on which a first connector with spring-shaped terminals to be connected to connection terminals of a personal digital assistance and a second connector to be connected to a cable (e.g., a USB cable) for connection to an information processing unit are mounted (e.g., Patent Literature 1). Moreover, a pogo pin connector has been also known, which includes, instead of the spring-shaped terminals, a plurality of movable pins (pogo pins) being extendable by springs.

### CITATION LIST

### Patent Literature

Patent Literature 1: JP 2006-173473 A

### SUMMARY OF INVENTION

### Technical Problem

However, the above-described personal digital assistance cradle includes the circuit board formed with connection lines each connecting each of the spring-shaped terminals of the first connector to a corresponding one of a plurality of terminals of the second connector, resulting in the disadvantage that a body size is large. Moreover, since a similar circuit board is provided at the pogo pin connector including the pogo pins, there are disadvantages that a connector body size is large and that a manufacturing cost is high.

The present invention is intended to provide a connector realizing compactification and manufacturing cost reduction.

### Solution to Problem

According to the present invention, there is provided a connector including: a case having an opposing surface facing external device; and a flat plate-shaped contact built in the case,

wherein the case includes a first opening which is formed at the opposing surface and through which a contact point of the contact to be connected to a connection terminal of the external device protrudes from the opposing surface, a receiver configured to receive a connector for external connection, and a holder configured to hold the contact, and the contact includes the contact point which is disposed in the first opening and which is to contact with the connection terminal of the external device, an elastic portion which is disposed in the case and which moves the contact point in a substantially perpendicular direction relative to the opposing surface, a contact portion which is disposed in the receiver and which is to contact with a connection terminal of the connector for external connection, a held portion which is formed between the elastic portion and the contact portion and which is held by the holder in the case, and a connection portion which is formed between the elastic portion and the contact portion and which connects between the contact point and the contact portion in the case.

Moreover, in the connector according to the present invention, the case includes a case body having the receiver and the holder, and a protective case having the opposing surface formed with the first opening, the case body includes a second opening for attachment of the protective case at a surface of the case body facing the external device, and the protective case is attached to the second opening of the case body to move in the substantially perpendicular direction relative to the opposing surface.

Moreover, in the connector according to the present invention, the holder has a holding surface which holds the held portion of the contact and which is substantially parallel to the opposing surface.

Moreover, the connector according to the present invention further includes: the plurality of contacts, wherein the case includes the at least one first opening through which each of the contact points included by each of the contacts protrudes from the opposing surface.

Moreover, in the connector according to the present invention, the connection portion includes a pitch changer configured to, when an arrangement pitch of the contact points of the contacts and an arrangement pitch of contact portions of the contacts are different from each other, change the arrangement pitch of the contact points of the contacts.

Moreover, in the connector according to the present invention, the connection portion includes an arrangement order changer configured to, when an arrangement order of the contact points of the contacts and an arrangement order of the contact portions of the contacts are different from each other, change the arrangement order of the contact points of the contacts.

Moreover, in the connector according to the present invention, the contacts include first and second contacts forming a differential pair, and the first and second contacts are configured such that a length of the first contact from a contact point to a contact portion is identical to a length of the second contact from a contact point to a contact portion.

Moreover, in the connector according to the present invention, the first and second contacts are formed in a planar or three-dimensional shape.

Moreover, in the connector according to the present invention, the first and second contacts are arranged such that a middle position of a line connecting between the contact point of the first contact and the contact point of the second contact and a middle position of a line connecting between the contact portion of the first contact and the contact portion of the second contact are on a line extending perpendicular to an arrangement direction of the contact points and an arrangement direction of the contact portions.

Moreover, in the connector according to the present invention, the connector for external connection is a MicroUSB connector, a USBType-C connector, or a USB3.1 connector.

Moreover, in the connector according to the present invention, an inserting and removing direction of the connector for external connection is a substantially parallel direction relative to the opposing surface direction, a substantially perpendicular direction relative to the opposing surface, or a direction inclined relative to the opposing surface, and an arrangement direction of the contact points and an arrangement direction of the contact portions are substantially parallel to each other.

Moreover, in the connector according to the present invention, an inserting and removing direction of the connector for external connection is a substantially parallel direction relative to the opposing surface direction, a substantially perpendicular direction relative to the opposing surface, or a direction inclined relative to the opposing surface, and an arrangement direction of the contact points and an arrangement direction of the contact portions are substantially perpendicular to each other.

Moreover, the connector according to the present invention further includes: a fixing portion configured to, while the contact point is connected to the connection terminal of the external device, fix the external device on the case.

Moreover, in the connector according to the present invention, the case includes a first case having a surface facing the external device and a second case having the holder, the first and second cases are connected together in a direction facing the external device, and the fixing portion is provided at the second case.

Moreover, the connector according to the present invention further includes: a first shell which is inserted into the case and which has, at a surface facing the external device, a connecting portion to be connected to the external device; and a second shell which is formed in the receiver and which contacts the first shell, wherein the first shell is in such a shape that the first shell covers at least the elastic portion and the held portion.

### Advantageous Effects of Invention

According to the present invention, a connector can be provided, which can realize compactification and manufacturing cost reduction and which has excellent high-speed transmission characteristics.

### BRIEF DESCRIPTION OF DRAWINGS

FIG. 1 is a perspective view illustrating the exterior appearance of a connector of a first embodiment.

FIG. 2 is a cross-sectional view illustrating the configuration of the connector of the first embodiment.

FIG. 3 is a perspective view illustrating the configuration of a contact of the first embodiment.

FIG. 4 is a plan view illustrating the configuration of the contact of the first embodiment.

FIG. 5 is a perspective view illustrating the exterior appearance of a connector of a second embodiment.

FIG. 6 is a cross-sectional view illustrating the configuration of the connector of the second embodiment.

FIG. 7 is a perspective view illustrating the configuration of a contact of the second embodiment.

FIG. 8 is a plan view illustrating the configuration of the contact of the second embodiment.

FIG. 9 is a perspective view illustrating the exterior appearance of a connector of a third embodiment.

FIG. 10 is a cross-sectional view illustrating the configuration of the connector of the third embodiment.

FIG. 11 is a perspective view illustrating the configuration of the inside of a case body of the third embodiment.

FIG. 12 is a perspective view illustrating the configuration of the inside of the case body of the third embodiment.

FIG. 13 is a perspective view illustrating the configuration of the inside of the case body of the third embodiment.

FIG. 14 is a perspective view illustrating the exterior appearance of a connector of a fourth embodiment.

FIG. 15 is a perspective view illustrating the exterior appearance of the connector of the fourth embodiment.

FIG. 16 is a cross-sectional view illustrating the configuration of the connector of the fourth embodiment.

FIG. 17 is a perspective view illustrating the configuration of the inside of a case of the fourth embodiment.

FIG. 18 is a perspective view illustrating the configuration of a contact of the fourth embodiment.

FIG. 19 is a perspective view illustrating the other configuration of the contact of the embodiments.

FIG. 20 is a plan view illustrating the other configuration of the contact of the embodiments.

FIG. 21 is a view illustrating the other configuration of the connector of the embodiments.

FIG. 22 is a perspective view illustrating the other configuration of the contact of the embodiments.

FIG. 23 is a plan view illustrating the other configuration of the contact of the embodiments.

FIG. 24 is a perspective view illustrating the other configuration of the contact of the embodiments.

FIG. 25 is a plan view illustrating the other configuration of the contact of the embodiments.

FIG. 26 is a perspective view illustrating the other configuration of the contact of the embodiments.

FIG. 27 is a perspective view illustrating the other configuration of the connector of the embodiments.

FIG. 28 is a perspective view illustrating the other configuration of the connector of the embodiments.

FIG. 29 is a perspective view illustrating the other configuration of the connector of the embodiments.

FIG. 30 is a plan view illustrating the other configuration of the connector of the embodiments.

FIG. 31 is a perspective view illustrating the other configuration of the connector of the embodiments.

FIG. 32 is a side view illustrating the other configuration of the connector of the embodiments.

### DESCRIPTION OF EMBODIMENTS

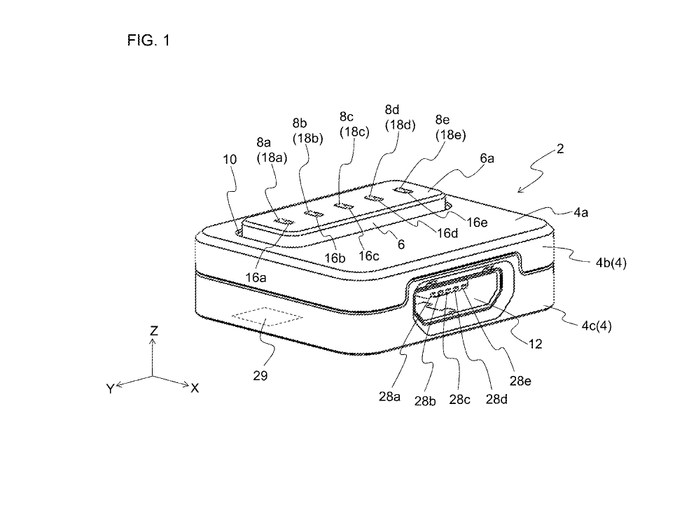

A connector of a first embodiment of the present invention will be described below with reference to drawings. FIG. 1 is a perspective view illustrating the exterior appearance of the connector of the first embodiment. Note that an XYZ orthogonal coordinate system is set in the drawings (FIGS. 1 to 4) illustrating, e.g., the configuration of the connector of the present embodiment, and, e.g., the position relationship among members will be described with reference to such an orthogonal coordinate system. It is set such that an X-axis is parallel to a inserting direction in which a later-described MicroUSB connector is inserted into a later-described receiver 12, that a Y-axis is parallel to the arrangement direction of a plurality of later-described contacts 8a to 8e, and that a Z-axis is perpendicular to the upper surface of a later-described case body 4. Moreover, it is set such that a removing direction in which the MicroUSB connector is removed is a positive X-direction, that the inserting direction in which the MicroUSB connector is inserted is a negative X-direction, that the direction toward the contact 8a is a positive Y-direction, that the direction toward the contact 8e is a negative Y-direction, that the direction toward the upper surface of the case body 4 is a positive Z-direction, and that the direction toward the lower surface of the case body 4 is a negative Z-direction.

As illustrated in FIG. 1, a connector 2 includes the case body 4, a protective case 6, the plurality of contacts 8a to 8e (in the present embodiment, five contacts), a magnet 29a, and a not-shown magnet. In the connector 2, external device (not shown) such as a personal digital assistance is pressed against the upper surface of the protective case 6. Accordingly, each of contact points 18a to 18e of the contacts 8a to 8e comes into contact with a corresponding one of connection terminals of the external device, and then, the contact points 18a to 18e and the connection terminals are electrically connected together.

The case body 4 is configured such that an upper case 4b and a lower case 4c formed of insulating members are connected together in the perpendicular direction (the Z-direction), and the contacts 8a to 8e are built in the case body 4. Moreover, at the surface of the case body 4 (the upper case 4b) facing the external device, i.e., the surface 4a of the case body 4 on the upper side (a positive Z-direction side), a rectangular second opening 10 for attachment of the protective case 6 is formed. Further, the case body 4 (the lower case 4c) includes the receiver 12 configured to receive a connector for external connection (in the present embodiment, a not-shown MicroUSB connector).

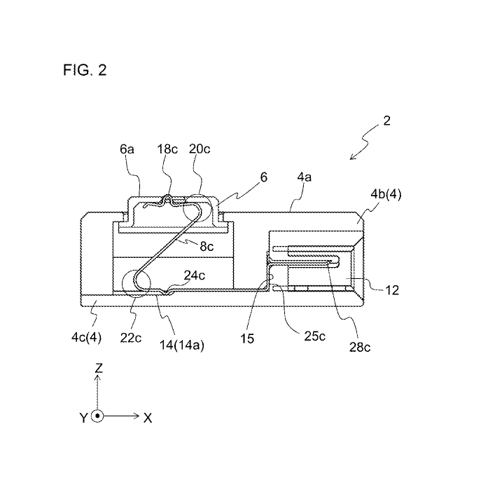

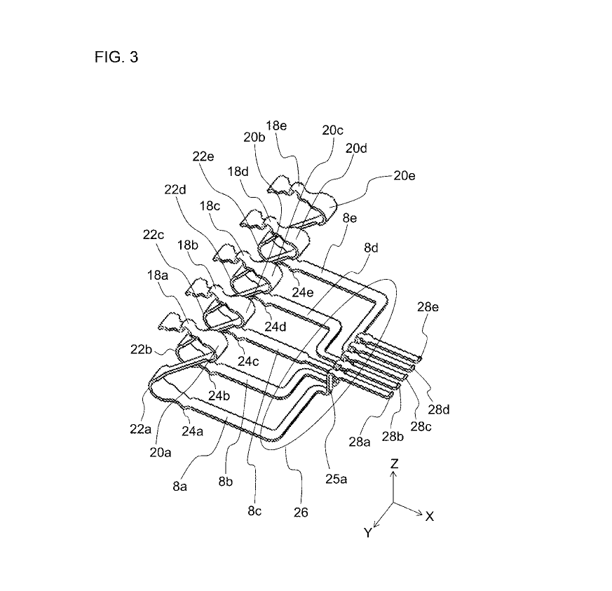

FIG. 2 is a view of the XZ cross section of the connector 2 of the first embodiment from a positive Y-direction side. As illustrated in FIG. 2, the case body 4 (the lower case 4c) includes a holder 14 configured to hold held portions 24a to 24e (see FIG. 3) of the contacts 8a to 8e, and the holder 14 has a holding surface 14a substantially parallel to an opposing surface 6a (the XY plane). The holder 14 is provided to receive the elastic force of elastic portions 20a to 20e, 22a to 22e (see FIG. 3) of the contacts 8a to 8e. The case body 4 (the lower case 4c) further includes a holder 15 configured to hold held portions 25a, 25c and three not-shown held portions of the contacts 8a to 8e (see FIG. 3), and the holder 15 is provided to prevent the contacts 8a to 8e from displacing relative to the case body 4 due to pressing force generated when the MicroUSB connector is pressed into the receiver 12.

As illustrated in FIG. 1, the protective case 6 has the opposing surface 6a facing the external device, and is attached to the second opening 10 of the case body 4 so as to be movable in the direction (the Z-direction) substantially perpendicular to the opposing surface 6a. Moreover, at the opposing surface 6a of the protective case 6, first openings 16a to 16e through each of which a corresponding one of the contact points 18a to 18e protrudes from the opposing surface 6a are formed.

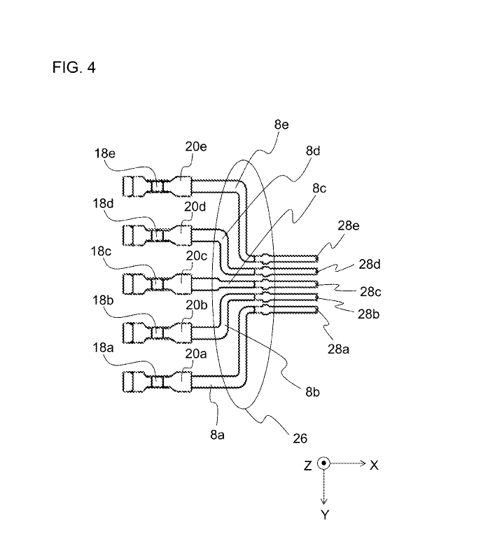

FIG. 3 is a perspective view illustrating the configuration of five contacts 8a to 8e of the connector 2 of the first embodiment, and FIG. 4 is a plan view of such a configuration from the above. Each of the contacts 8a to 8e is in a flat plate shape, and as illustrated in FIGS. 1 to 4, includes a corresponding one of the contact points 18a to 18e; corresponding ones of the elastic portions 20a to 20e, 22a to 22e; a corresponding one of the held portions 24a to 24e; a corresponding one of the held portions 25a, 25c and three not-shown held portions; a connection portion 26; and a corresponding one of contact portions 28a to 28e. Each of the contact points 18a to 18e is disposed in a corresponding one of the first openings 16a to 16e, and comes into contact with a corresponding one of the connection terminals of the external device when the external device is pressed against the opposing surface 6a of the protective case 6. Since the contact points 18a to 18e are maintained protruding from the opposing surface 6a, it is ensured that the contact points 18a to 18e and the connection terminals of the external device contact each other when the external device is pressed against the opposing surface 6a of the protective case 6.

Each of the elastic portions 20a to 20e, 22a to 22e is disposed in the case body 4, and moves a corresponding one of the contact points 18a to 18e in the substantially perpendicular direction (the Z-direction) relative to the opposing surface 6a. That is, when the external device is pressed against the opposing surface 6a, the elastic portions 20a to 20e, 22a to 22e are compressed, and accordingly, the contact points 18a to 18e and the protective case 6 move in the negative Z-direction. Each of the held portions 24a to 24e is formed between a corresponding one of the elastic portions 22a to 22e and a corresponding one of the contact portions 28a to 28e, and is held by the holding surface 14a of the holder 14 in the case body 4. Each of the held portions 25a, 25c and three not-shown held portions is formed between a corresponding one of the elastic portions 22a to 22e and a corresponding one of the contact portions 28a to 28e, and is held by the holder 15 in the case body 4.

The connection portion 26 is formed between each of the elastic portions 22a to 22e and each of the contact portions 28a to 28e, and connects between each of the contact points 18a to 18e and each of the contact portions 28a to 28e in the case body 4. Moreover, as illustrated in FIGS. 3 and 4, the arrangement pitch (the arrangement interval) of the contact points 18a to 18e in the arrangement direction (the Y-direction) thereof and the arrangement pitch (the arrangement interval) of the contact portions 28a to 28e in the arrangement direction (the Y-direction) thereof are different from each other. Thus, the connection portion 26 also functions as a pitch changer configured to change the arrangement pitch of the contact points 18a to 18e.

Each of the contact portions 28a to 28e is disposed at the receiver 12, and has the surface exposed in the negative Z-direction in the receiver 12. When the MicroUSB connector is inserted into the receiver 12, each of the contact portions 28a to 28e comes into contact with a corresponding one of the connection terminals of the MicroUSB connector.

As illustrated in FIG. 1, the magnet 29 is attached on the side (the positive Y-direction side) close to the contact 8a in the lower case 4c. Moreover, the not-shown magnet is attached on the side (a negative Y-direction side) close to the contact 8e in the lower case 4c. The magnet 29 and the not-shown magnet are provided as fixing portions configured to fix the external device on the opposing surface 6a while each of the contact points 18a to 18e of the contacts 8a to 8e is connected to a corresponding one of the connection terminals of the external device.

Note that the magnets serving as the fixing portions are preferably provided at the lower case 4c having the holder 14 (the holding surface 14a). This is because if the magnets are provided at the upper case 4b not including the holder 14, the upper case 4b and the lower case 4c might be separated from each other. That is, the holder 14 (the holding surface 14a) receives external force generated in the negative Z-direction when the external device is pressed against the opposing surface 6a. With the magnets provided in the case body 4, fixing force for fixing the external device is generated in the direction (the positive Z-direction) opposite to the external force. Thus, in the case of providing the magnets at the upper case 4b not including the holder 14, the fixing force for pressing the upper case 4b upward in the positive Z-direction and the external force for pressing the lower case 4c in the negative Z-direction repel each other, and as a result, connection between the upper case 4b and the lower case 4c is weakened. On the other hand, in the case of providing the magnets at the lower case 4c including the holder 14, both of the fixing force acting in the positive Z-direction and the external force acting in the negative Z-direction are provided on the lower case 4c, and therefore, connection between the upper case 4b and the lower case 4c is not weakened.

Next, the case where the external device and the MicroUSB connector are inserted into the connector 2 of the first embodiment will be described. When the MicroUSB connector is inserted into the receiver 12 of the connector 2 illustrated in FIGS. 1 and 2, each of the contact portions 28a to 28e of the contacts 8a to 8e comes into contact with a corresponding one of the connection terminals of the external device. When the external device is pressed against the opposing surface 6a of the protective case 6 of the connector 2 illustrated in FIGS. 1 and 2, each of the contact points 18a to 18e of the contacts 8a to 8e comes into contact with a corresponding one of the connection terminals of the MicroUSB connector. Moreover, the magnet 29 and the not-shown magnet fix the external device on the opposing surface 6a by magnetic force. Then, the external device and the MicroUSB connector are electrically connected together via the connector 2 so that data communication with the external device and power supply to the external device are performed.

According to the connector of the first embodiment, the contacts each configured to connect between the contact point and the contact portion are built in the case body. Thus, it is not necessary to build a circuit board etc. in the case body, and therefore, the size of a connector body can be reduced. Moreover, a manufacturing cost can be reduced. With the existing MicroUSB connector, data communication with the external device and charging of the external device can be facilitated.

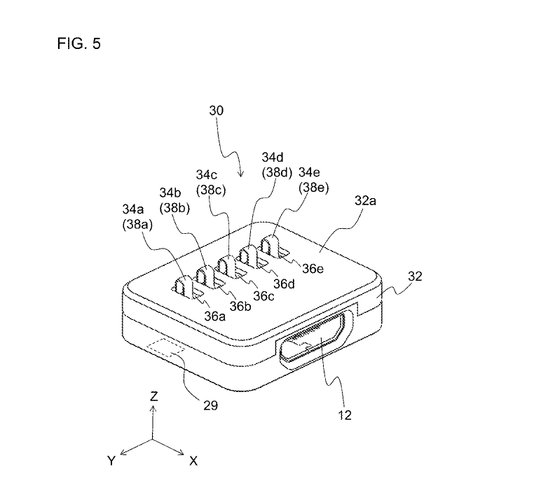

Next, a connector of a second embodiment of the present invention will be described with reference to drawings. FIG. 5 is a perspective view illustrating the exterior appearance of the connector of the second embodiment. Note that the same reference numerals are used to represent elements of the connector of the second embodiment having the identical configuration to that of the connector 2 illustrated in FIGS. 1 and 2, and the description thereof will not be repeated. In the drawings (FIGS. 5 to 8) illustrating the configuration of the connector etc. of the present embodiment, the XYZ orthogonal coordinate system similar to that illustrated in FIGS. 1 to 4 is also set, and, e.g., the position relationship among members will be described with reference to such an orthogonal coordinate system.

As illustrated in FIG. 5, a connector 30 includes a case 32 and a plurality of contacts 34a to 34e (in the present embodiment, five contacts). In the connector 30, external device (not shown) such as a personal digital assistance is attached to the upper surface of the case 32. Accordingly, each of contact points 38a to 38e of the contacts 34a to 34e comes into contact with a corresponding one of connection terminals of the external device, and then, the contact points 38a to 38e and the connection terminals are electrically connected together.

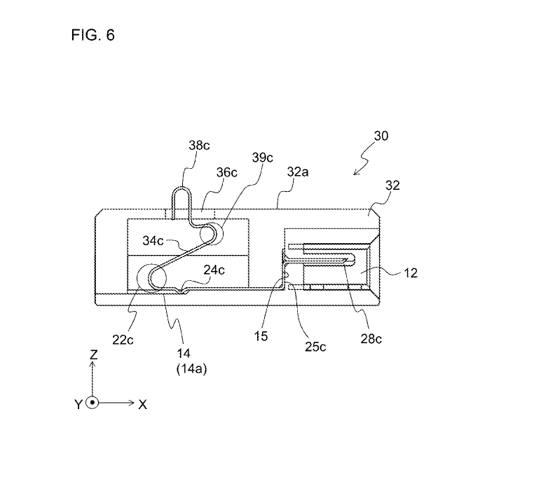

FIG. 6 is a view of the XZ cross section of the connector 30 of the second embodiment from a positive Y-direction side. The case 32 is substantially in a rectangular parallelepiped shape, and is formed of an insulating member. The contacts 34a to 34e are built in the case 32. Moreover, as illustrated in FIG. 5, the case 32 has an opposing surface 32a facing the external device, and first openings 36a to 36e through each of which a corresponding one of the contact points 38a to 38e protrudes from the opposing surface 32a are formed at the opposing surface 32a of the case 32.

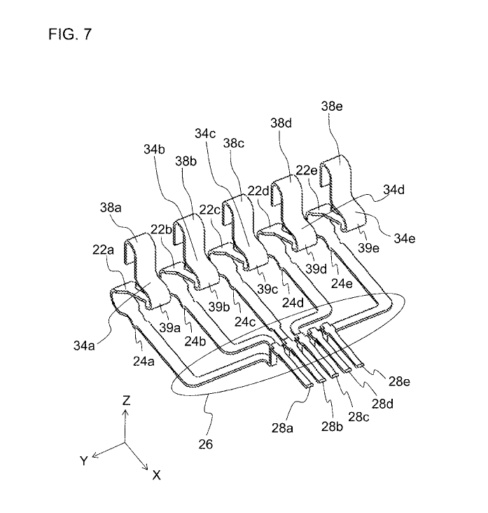

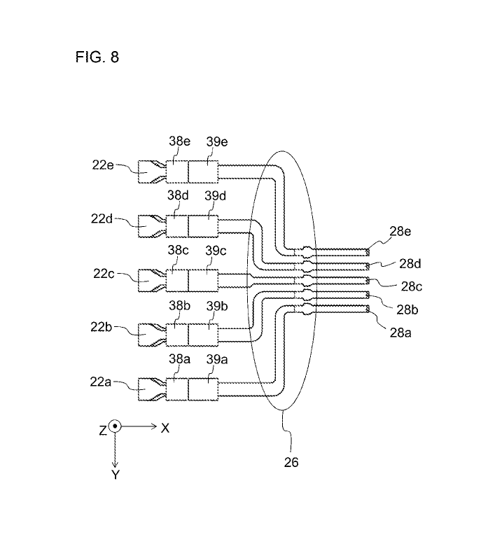

FIG. 7 is a perspective view illustrating the configuration of five contacts 34a to 34e of the connector 30 of the second embodiment, and FIG. 8 is a plan view of such a configuration from the above. Each of the contacts 34a to 34e is in a flat plate shape, and as illustrated in FIGS. 5 to 8, includes a corresponding one of the contact points 38a to 38e; corresponding ones of elastic portions 39a to 39e, 22a to 22e; a corresponding one of held portions 24a to 24e; a corresponding one of held portions 25a, 25c and three not-shown held portions; a connection portion 26; and a corresponding one of contact portions 28a to 28e. Each of the contact points 38a to 38e is disposed in a corresponding one of the first openings 36a to 36e, and comes into contact with a corresponding one of the connection terminals of the external device when the external device is attached to the opposing surface 32a of the case 32.

Each of the elastic portions 39a to 39e, 22a to 22e is disposed in the case 32, and moves a corresponding one of the contact points 38a to 38e in the substantially perpendicular direction (the Z-direction) relative to the opposing surface 32a. That is, when the external device is attached to the opposing surface 32a, the elastic portions 39a to 39e, 22a to 22e are compressed, and accordingly, the contact points 38a to 38e move in the negative Z-direction.

Next, the case where the external device and a MicroUSB connector are inserted into the connector 30 of the second embodiment will be described. When the MicroUSB connector is inserted into a receiver 12 of the connector 30 illustrated in FIGS. 5 and 6, each of the contact portions 28a to 28e of the contacts 34a to 34e comes into contact with a corresponding one of connection terminals of the MicroUSB connector. When the external device is pressed against the opposing surface 32a of the case 32 of the connector 30 illustrated in FIGS. 5 and 6, each of the contact points 38a to 38e of the contacts 34a to 34e comes into contact with a corresponding one of the connection terminals of the external device. Moreover, a magnet 29 and a not-shown magnet fix the external device on the opposing surface 32a by magnetic force. Then, the external device and the MicroUSB connector are electrically connected together via the connector 30 so that data communication with the external device and power supply to the external device are performed.

According to the connector of the second embodiment, the contacts each configured to connect between the contact point and the contact portion are built in the case. Thus, it is not necessary to build a circuit board etc. in the case, and therefore, the size of a connector body can be reduced. Moreover, a manufacturing cost can be reduced. With the existing MicroUSB connector, data communication with the external device and charging of the external device can be facilitated.

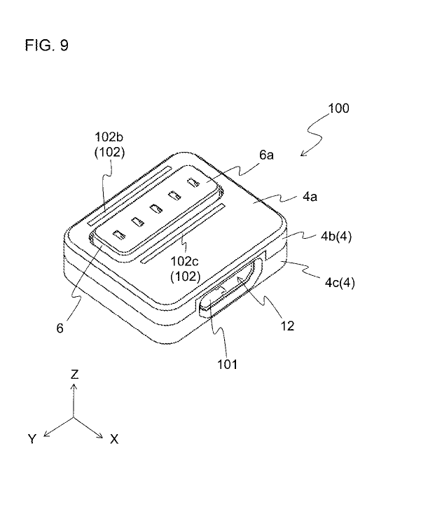

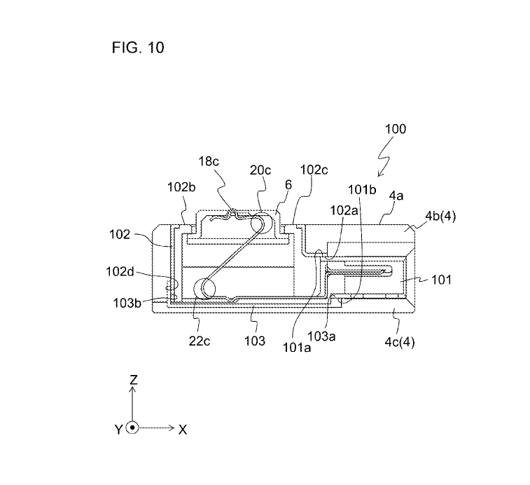

Next, a connector of a third embodiment of the present invention will be described with reference to drawings. FIG. 9 is a perspective view illustrating the exterior appearance of the connector of the third embodiment, and FIG. 10 is a view illustrating the XZ cross section of the connector of the third embodiment from a positive Y-direction side. Note that the same reference numerals are used to represent elements of the connector of the third embodiment having the identical configuration to that of the connector 2 illustrated in FIGS. 1 and 2, and the description thereof will not be repeated. In the drawings (FIGS. 9 to 13) illustrating the configuration of the connector etc. of the present embodiment, the XYZ orthogonal coordinate system similar to that illustrated in FIGS. 1 to 4 is also set, and, e.g., the position relationship among members will be described with reference to such an orthogonal coordinate system.

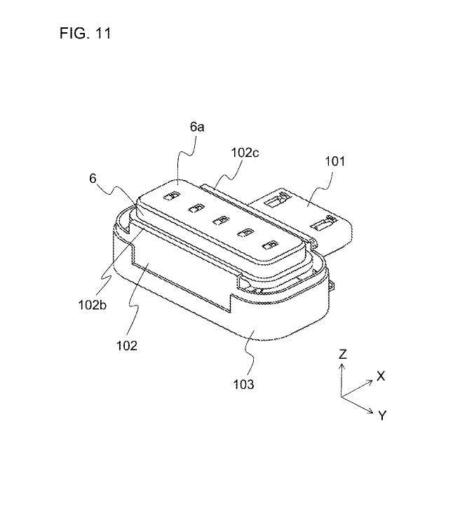

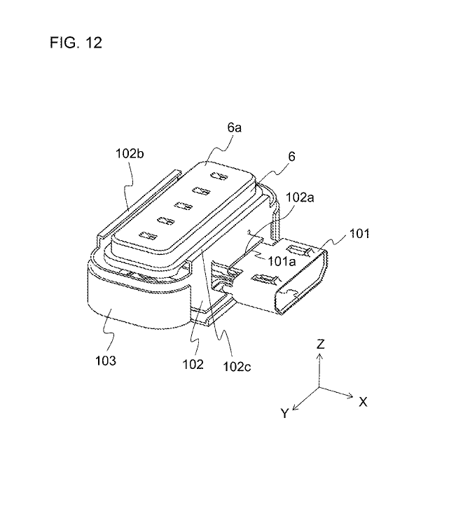

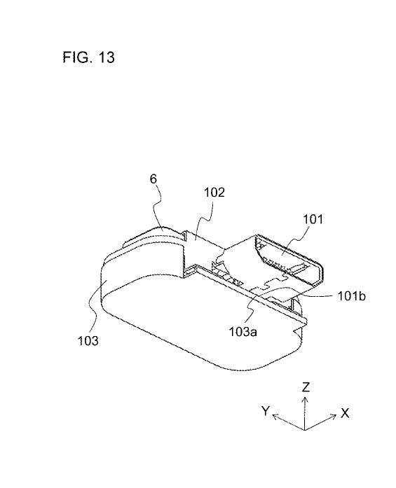

As illustrated in FIGS. 9 and 10, a connector 100 includes a MicroUSB connector shell (hereinafter simply referred to as a “connector shell”) 101, an upper shell 102, and a lower shell 103. FIGS. 11 and 12 are perspective views illustrating, from the above, the configuration of the inside of a case body 4, and FIG. 13 is a perspective view illustrating, from the below, the configuration of the inside of the case body 4.

The connector shell 101 is formed in a receiver 12, and is press-fitted into a lower case 4c of the case body 4. The connector shell 101 contacts the upper shell 102. Specifically, as illustrated in FIGS. 10 and 12, a connector-side contact portion 101a of the connector shell 101 and an upper shell contact portion 102a of the upper shell 102 are connected together. Moreover, the connector shell 101 contacts the lower shell 103. Specifically, as illustrated in FIGS. 10 and 13, a connector-side contact portion 101b of the connector shell 101 and a lower shell contact portion 103a of the lower shell 103 are connected together.

The upper shell 102 is insert-molded to an upper case 4b of the case body 4, and as illustrated in FIG. 9, connecting portions 102b, 102c for connecting external device to a surface 4a of the case body 4 facing the external device are exposed through the upper shell 102. As illustrated in FIGS. 11 and 12, the upper shell 102 is in such a shape that the upper shell 102 covers elastic portions 20a to 20e, 22a to 22e, held portions 24a to 24e, and a connection portion 26 of contacts 8a to 8e, and is disposed to contact the lower shell 103 inside of the lower shell 103.

The lower shell 103 is insert-molded to the lower case 4c of the case body 4, and as illustrated in FIGS. 11 and 12, is in such a shape that the lower shell 103 covers the elastic portions 20a to 20e, 22a to 22e, the held portions 24a to 24e, and the connection portion 26 of the contacts 8a to 8e. Moreover, the lower shell 103 is disposed to contact the upper shell 102 outside of the upper shell 102. Note that in the present embodiment, the upper shell 102 and the lower shell 103 are in such a shape that both cover the elastic portions 20a to 20e, 22a to 22e, the held portions 24a to 24e, and the connection portion 26, but at least one of the upper shell 102 or the lower shell 103 may be in such a shape that the one of the upper shell 102 or the lower shell 103 at least covers the elastic portions 20a to 20e, 22a to 22e and the held portions 24a to 24e.

Next, the case where the external device and a MicroUSB connector are inserted into the connector 100 of the third embodiment will be described. When the MicroUSB connector is inserted into the receiver 12 of the connector 100, the connector shell 101 and a plug shell of the MicroUSB connector come into contact with each other. When the external device is pressed against an opposing surface 6a of the connector 100, the connecting portions 102b, 102c of the upper shell 102 and a chassis of the external device come into contact with each other. The connector shell 101 contacting the plug shell of the MicroUSB connector contacts the upper shell 102 and the lower shell 103, and the upper shell 102 contacts the lower shell 103 and the chassis of the external device. Thus, the ground of the plug shell of the MicroUSB connector and the ground of the chassis of the external device are connected together.

According to the connector of the third embodiment, the contacts each configured to connect between the contact point and the contact portion are built in the case body. Thus, it is not necessary to build a circuit board etc. in the case body, and therefore, the size of a connector body can be reduced. Moreover, a manufacturing cost can be reduced. With the existing MicroUSB connector, data communication with the external device and charging of the external device can be facilitated. Moreover, the upper and lower shells which are insert-molded to the case body and which is in such a shape that the upper and lower shells at least cover the elastic portions and the held portions are provided, and are connected to the chassis of the external device and the plug shell of the MicroUSB connector. This can prevent noise caused in the connector from exiting to the outside, and can prevent noise from entering the connector from the outside.

Note that in the connector of the third embodiment, the upper shell 102 is disposed inside the lower shell 103, but the present invention is not limited to such a configuration. For example, the configuration may be employed, in which an upper shell is disposed outside a lower shell.

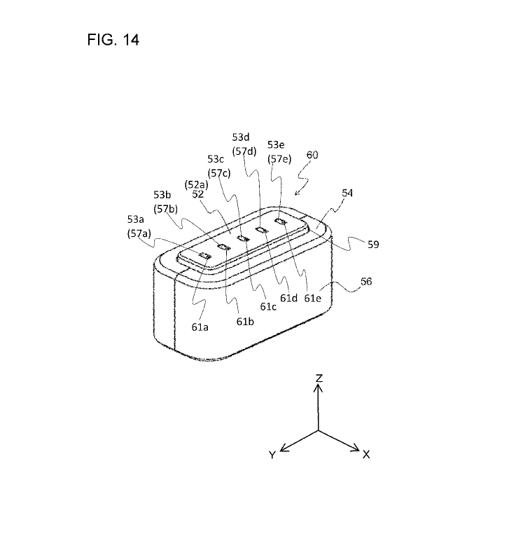

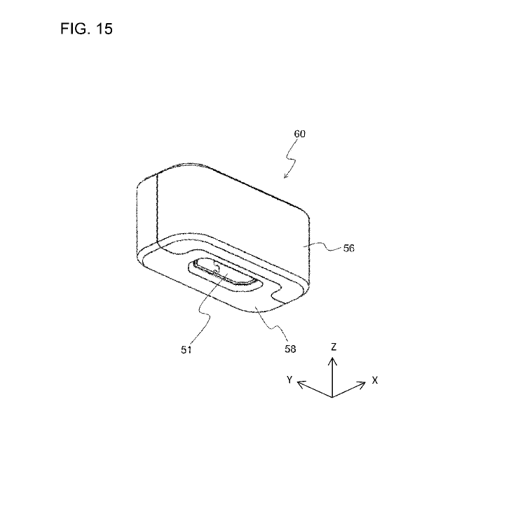

Next, a connector of a fourth embodiment of the present invention will be described with reference to drawings. FIG. 14 is a perspective view illustrating, from the above, the exterior appearance of the connector of the fourth embodiment, and FIG. 15 is a perspective view illustrating such an exterior appearance from the below. Note that the same reference numerals are used to represent elements of the connector of the fourth embodiment having the identical configuration to that of the connector 2 illustrated in FIGS. 1 and 2, and the description thereof will not be repeated. In the drawings (FIGS. 14 to 18) illustrating the configuration of the connector etc. of the present embodiment, the XYZ orthogonal coordinate system similar to that illustrated in FIGS. 1 to 4 is also set, and, e.g., the position relationship among members will be described with reference to such an orthogonal coordinate system. It is set such that the X-axis is parallel to an opposing surface 52a along the direction perpendicular to the arrangement direction of a plurality of later-described contacts 53a to 53e, that the Y-axis is parallel to the arrangement direction of the contacts 53a to 53e, and that the Z-axis is perpendicular to the upper surface of a later-described case body 56.

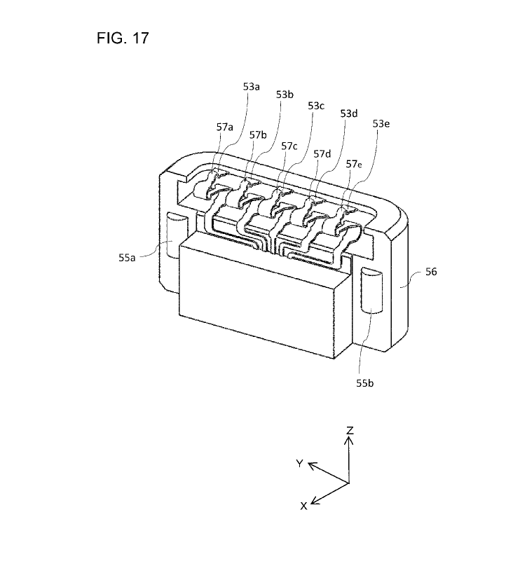

As illustrated in FIGS. 14 and 15, a connector 60 includes the case body 56, a protective case 52, the plurality of contacts 53a to 53e (in the present embodiment, five contacts), and magnets 55a, 55b (see FIG. 17). In the connector 60, external device (not shown) such as a personal digital assistance is pressed against the upper surface 52a of the protective case 52. Therefore, each of contact points 57a to 57e of the contacts 53a to 53e comes into contact with a corresponding one of connection terminals of the external device contact, and then, the contact points 57a to 57e and the connection terminals are electrically connected together.

As illustrated in FIG. 14, the contacts 53a to 53e are built in the case body 56. Moreover, at the surface of the case body 56 facing the external device, i.e., a surface 54 of the case body 56 on the upper side (a positive Z-direction side), a rectangular second opening 59 for attachment of the protective case 52 is formed. Further, as illustrated in FIG. 15, the case body 56 includes, at the surface facing the surface 54 facing the external device, i.e., a surface 58 of the case body 56 on the lower side (a negative Z-direction side), a receiver 51 configured to receive a connector for external connection (in the present embodiment, a not-shown MicroUSB connector).

As illustrated in FIG. 14, the protective case 52 has the opposing surface 52a facing the external device, and is attached to the second opening 59 of the case body 56 to move in the direction (the Z-direction) substantially perpendicular to the opposing surface 52a. Moreover, at the opposing surface 52a of the protective case 52, first openings 61a to 61e through each of which a corresponding one of the contact points 57a to 57e protrudes from the opposing surface 52a are formed.

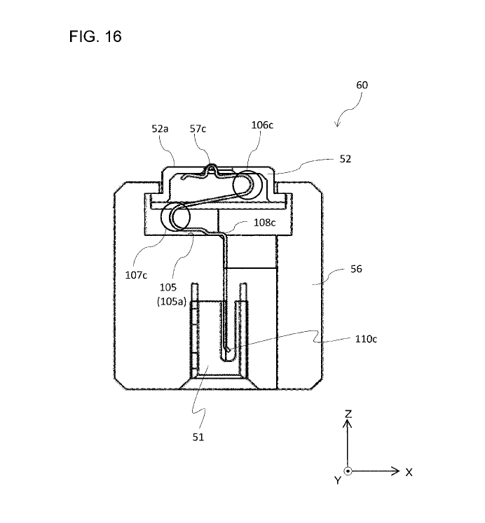

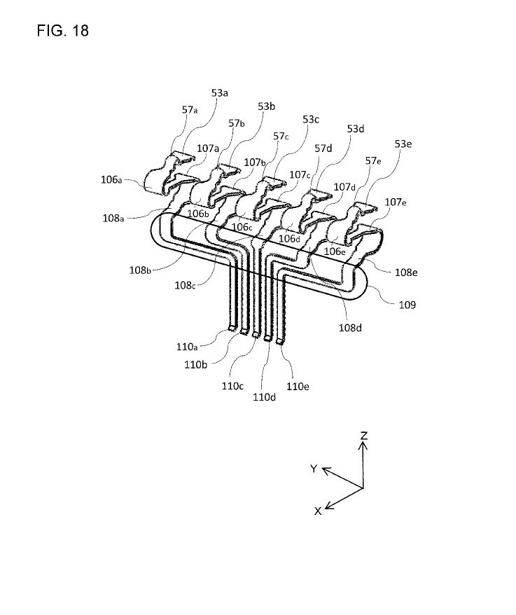

FIG. 16 is a view of the XZ cross section of the connector 60 of the fourth embodiment from a positive Y-direction side. As illustrated in FIG. 16, the case body 56 includes a holder 105 configured to hold held portions 108a to 108e (see FIG. 18) of the contacts 53a to 53e, and the holder 105 has a holding surface 105a substantially parallel to the opposing surface 52a (the XY plane). The holder 105 is provided to receive the elastic force of elastic portions 106a to 106e, 107a to 107e (see FIG. 18) of the contacts 53a to 53e.

FIG. 17 is a perspective view illustrating the configuration of the inside of the case body 56. As illustrated in FIG. 17, the magnet 55a is attached to an inner portion of the case body 56 close to the contact 53a (the positive Y-direction side). Moreover, the magnet 55b is attached to an inner portion of the case body 56 close to the contact 53e (a negative Y-direction side). The magnets 55a, 55b are provided as fixing portions configured to fix the external device on the opposing surface 52a while each of the contact points 57a to 57e of the contacts 53a to 53e is connected to a corresponding one of the connection terminals of the external device.

FIG. 18 is a perspective view illustrating the configuration of five contacts 53a to 53e of the connector 60 of the fourth embodiment. Each of the contacts 53a to 53e is in a flat plate shape, and as illustrated in FIG. 18, includes a corresponding one of the contact points 57a to 57e; corresponding ones of the elastic portions 106a to 106e, 107a to 107e; a corresponding one of the held portions 108a to 108e; a connection portion 109; and a corresponding one of contact portions 110a to 110e. Each of the contact points 57a to 57e is disposed in a corresponding one of the first openings 61a to 61e, and comes into contact with a corresponding one of the connection terminals of the external device when the external device is pressed against the opposing surface 52a of the protective case 52. Since the contact points 57a to 57e are maintained protruding from the opposing surface 52a, it is ensured that each of the contact points 57a to 57e contacts a corresponding one of the connection terminals of the external device when the external device is pressed against the opposing surface 52a of the protective case 52.

Each of the elastic portions 106a to 106e, 107a to 107e is disposed in the case body 56, and moves a corresponding one of the contact points 57a to 57e in the substantially perpendicular direction (the Z-direction) relative to the opposing surface 52a. That is, when the external device is pressed against the opposing surface 52a, the elastic portions 106a to 106e, 107a to 107e are compressed, and accordingly, the contact points 57a to 57e and the protective case 52 move in the negative Z-direction. Each of the held portions 108a to 108e is formed between a corresponding one of the elastic portions 107a to 107e and a corresponding one of the contact portions 110a to 110e, and is held by the holding surface 105a of the holder 105 in the case body 56.

The connection portion 109 is formed between each of the elastic portions 107a to 107e and each of the contact portions 110a to 110e, and connects each of the contact points 57a to 57e to a corresponding one of the contact portions 110a to 110e in the case body 56. Moreover, as illustrated in FIG. 18, the arrangement pitch (the arrangement interval) of the contact points 57a to 57e in the arrangement direction (the Y-direction) thereof and the arrangement pitch (the arrangement interval) of the contact portions 110a to 110e in the arrangement direction (the Y-direction) thereof are different from each other. Thus, the connection portion 109 also functions as a pitch changer configured to change the arrangement pitch of the contact points 57a to 57e.

Each of the contact portions 110a to 110e is disposed at the receiver 51, and has the surface exposed in the negative X-direction in the receiver 51. When the MicroUSB connector is inserted into the receiver 51, each of the contact portions 110a to 110e comes into contact with a corresponding one of connection terminals of the MicroUSB connector.

Next, the case where the external device and the MicroUSB connector are inserted into the connector 60 of the fourth embodiment will be described. When the MicroUSB connector is inserted into the receiver 51 of the connector 60 illustrated in FIGS. 15 and 16, each of the contact portions 110a to 110e of the contacts 53a to 53e comes into contact with a corresponding one of the connection terminals of the MicroUSB connector. When the external device is pressed against the opposing surface 52a of the protective case 52 of the connector 60 illustrated in FIGS. 14 and 16, each of the contact points 57a to 57e of the contacts 53a to 53e comes into contact with a corresponding one of the connection terminals of the external device. Moreover, the magnets 55a, 55b fix the external device on the opposing surface 52a by magnetic force. Then, the external device and the MicroUSB connector are electrically connected together via the connector 60 so that data communication with the external device and power supply to the external device are performed.

According to the connector of the fourth embodiment, the contacts each configured to connect between the contact point and the contact portion are built in the case body. Thus, it is not necessary to build a circuit board etc. in the case body, and therefore, the size of a connector body can be reduced. Moreover, a manufacturing cost can be reduced. With the existing MicroUSB connector, data communication with the external device and charging of the external device can be facilitated.

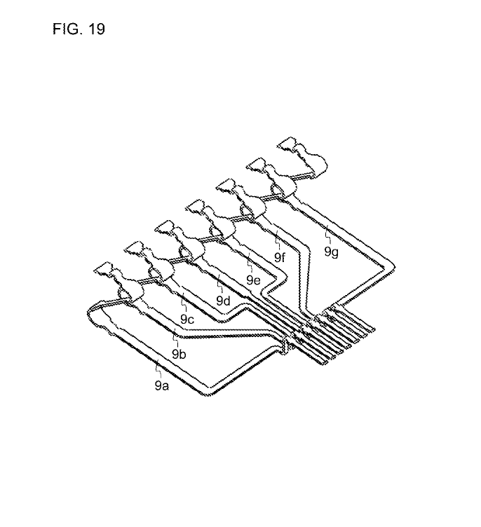

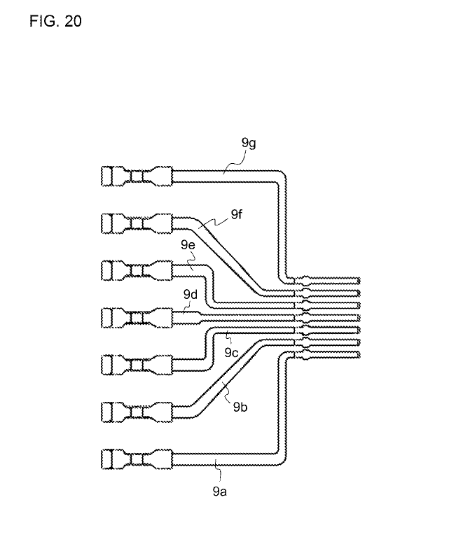

Note that in each of the above-described embodiments, the connector 2 (30, 100) including five contacts 8a to 8e (34a to 34e) has been described as an example. However, a connector including one to four contacts or six or more contacts may be employed. As in, e.g., a perspective view of FIG. 19 and a plan view of FIG. 20 from the above, a connector (not shown) may include seven contacts 9a to 9g.

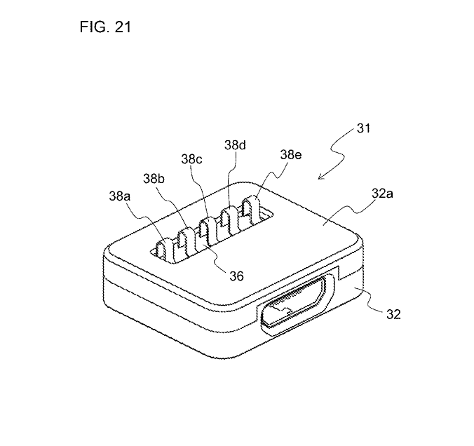

In each of the above-described embodiments, the configuration in which each of the contact points 18a to 18e (38a to 38e) of the contacts 8a to 8e (34a to 34e) protrudes from a corresponding one of the first openings 16a to 16e (36a to 36e) of the opposing surface 6a (32a) has been described as an example. However, the configuration may be employed, in which two or more contact points protrude from a single first opening of an opposing surface. As in, e.g., a connector 31 illustrated in FIG. 21, a single first opening 36 through which contact points 38a to 38e protrude from an opposing surface 32a is formed.

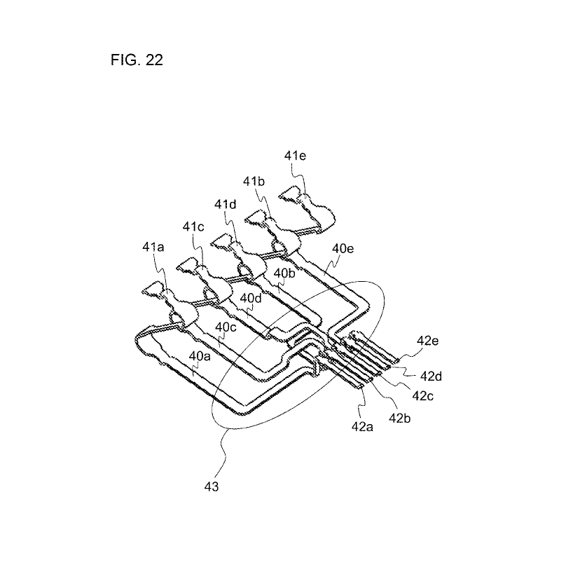

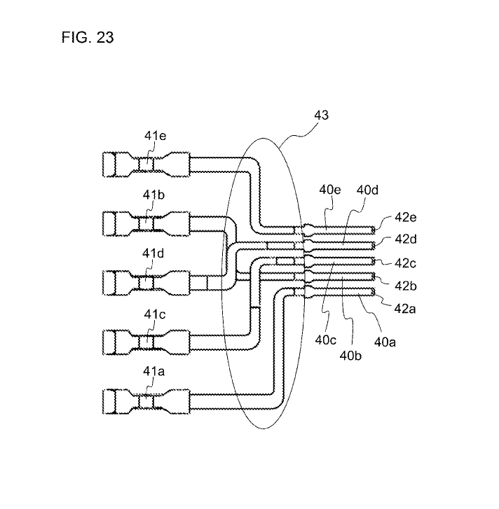

In each of the above-described embodiments, the following case has been described as an example: the arrangement order of the contact points 18a to 18e (38a to 38e) of the contacts 8a to 8e (34a to 34e) is the same as that of the contact portions 28a to 28e of the contacts 8a to 8e (34a to 34e), i.e., the arrangement order of the connection terminals of the external device is the same as that of the connection terminals of the MicroUSB connector. On the other hand, the arrangement order of the contact points 18a to 18e (38a to 38e) of the contacts 8a to 8e (34a to 34e) may be different from that of the contact portions 28a to 28e of the contacts 8a to 8e (34a to 34e). In this case, the connection portion 26 functions as an arrangement order changer configured to change the arrangement order of the contact points 18a to 18e (38a to 38e) of the contacts 8a to 8e (34a to 34e). FIG. 22 is a perspective view illustrating the configuration of contacts 40a to 40e in the case of a contact point arrangement order different from a contact portion arrangement order, and FIG. 23 is a plan view of such a configuration from the above.

As illustrated in FIGS. 22 and 23, in the case where the arrangement order of contact points 41a to 41e of the contacts 40a to 40e is different from that of contact portions 42a to 42e, a connection portion 43 changes the arrangement order of the contact points 41a to 41e. That is, the arrangement order of the contact points 41a to 41e is changed from an arrangement order of 41a, 41b, 41c, 41d, 41e to an arrangement order of 41a, 41c, 41d, 41b, 41e in such a manner that the contacts 40b to 40d are crossed each other.

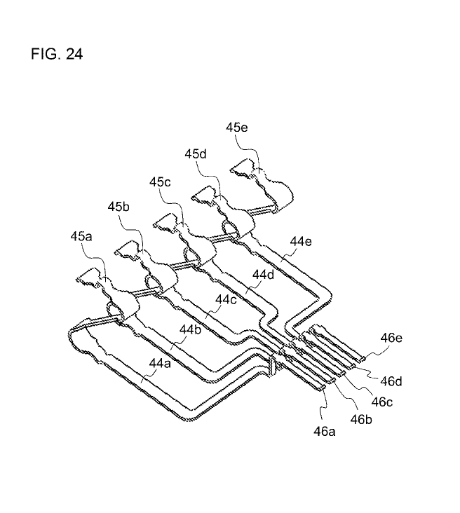

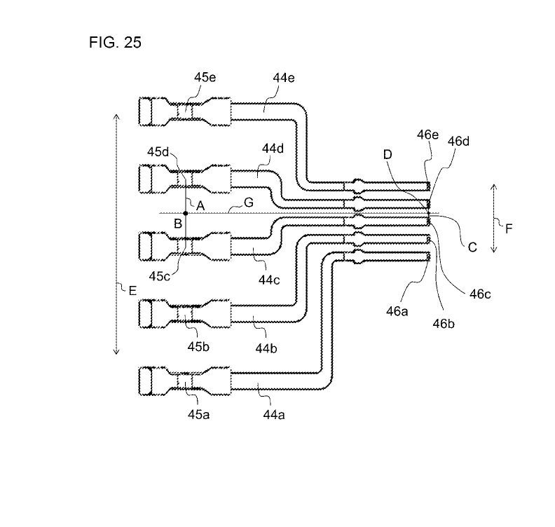

In each of the above-described embodiments, in the case where the contacts 8a to 8e (34a to 34e) has a differential pair, the length from the contact point to the contact portion is preferably the same between two contacts (hereinafter referred to as “first and second contacts”) forming the differential pair in order to realize, e.g., high-speed data communication and high-speed charging at the differential pair. FIG. 24 is a perspective view illustrating an example of the configuration of the contacts including the first and second contacts forming the differential pair, and FIG. 25 is a plan view of such an example from the above.

As illustrated in FIGS. 24 and 25, a first contact 44c and a second contact 44d forming a differential pair are configured such that the length of the first contact 44c from a contact point 45c to a contact portion 46c is the same as the length of the second contact 44d from a contact point 45d to a contact portion 46d. That is, the first contact 44c and the second contact 44d are, as illustrated in FIG. 25, arranged such that a middle position B of a line A connecting between the contact point 45c of the first contact 44c and the contact point 45d of the second contact 44d and a middle position D of a line C connecting between the contact portion 46c of the first contact 44c and the contact portion 46d of the second contact 44d are on a line G extending perpendicular to an arrangement direction E of contact points 45a to 45e of contacts 44a to 44e and an arrangement direction F of contact portions 46a to 46e of the contacts 44a to 44e. Note that a connection portion between the first contact 44c and the second contact 44d is in a planer shape, and is configured such that the length from the contact point 45c to the contact portion 46c is the same as the length from the contact point 45d to the contact portion 46d. With such a configuration, the first contact 44c and the second contact 44d are easily configured such that the length of the first contact 44c from the contact point 45c to the contact portion 46c is the same as the length of the second contact 44d from the contact point 45d to the contact portion 46d. Moreover, with this configuration, high-speed transmission characteristics can be improved.

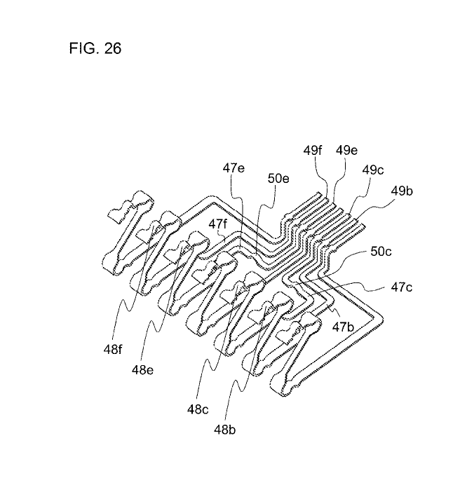

In the case where contacts include a plurality of differential pairs, the length from a contact point to a contact portion is preferably the same among pairs of first and second contacts each forming the differential pair. FIG. 26 is a perspective view illustrating an example of the configuration of contacts including pairs of first and second contacts forming a plurality of differential pairs. As illustrated in FIG. 26, a first contact 47b and a second contact 47c forming one of the differential pairs are configured such that the length of the first contact 47b from a contact point 48b to a contact portion 49b is the same as the length of the second contact 47c from a contact point 48c to a contact portion 49c. Specifically, a portion 50c connecting between the contact point 48c and the contact portion 49c in the second contact 47c is three-dimensionally formed, and therefore, adjustment is made such that the length of the first contact 47b from the contact point 48b to the contact portion 49b is the same as the length of the second contact 47c from the contact point 48c to the contact portion 49c.

As illustrated in FIG. 26, a first contact 47e and a second contact 47f forming the other differential pair are configured such that the length of the first contact 47e from a contact point 48e to a contact portion 49e is the same as the length of the second contact 47f from a contact point 48f to a contact portion 49f. Specifically, a portion 50e connecting between the contact point 48e and the contact portion 49e in the first contact 47e is three-dimensionally formed, and therefore, adjustment is made such that the length of the first contact 47e from the contact point 48e to the contact portion 49e is the same as the length of the second contact 47f from the contact point 48f to the contact portion 49f. With such a configuration, the high-speed transmission characteristics can be improved.

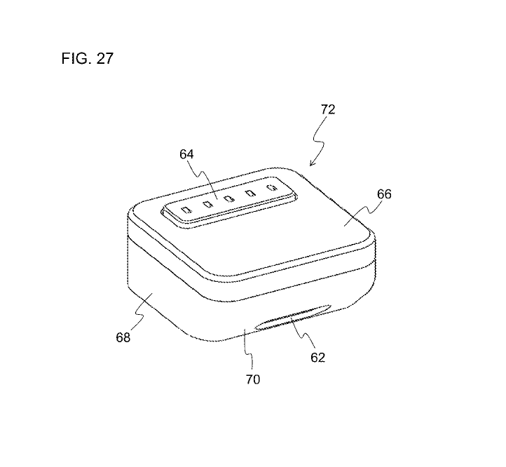

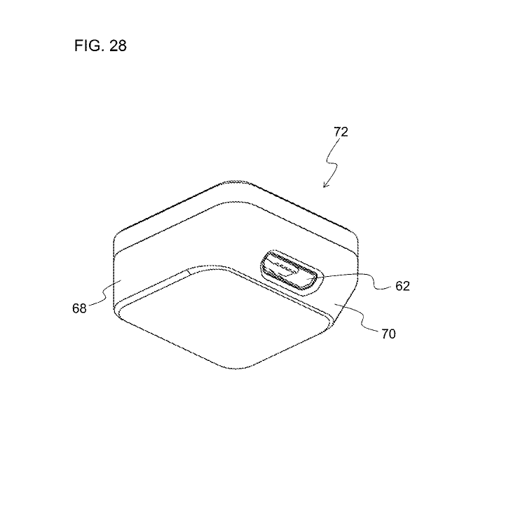

In the first to third embodiments described above, the connector configured such that the inserting and removing direction of the MicroUSB connector is a substantially parallel direction relative to the opposing surface and that the arrangement direction of the contact points and the arrangement direction of the contact portions are substantially parallel to each other has been described. In the fourth embodiment described above, the connector configured such that the inserting and removing direction of the MicroUSB connector is a substantially perpendicular direction relative to the opposing surface and that the arrangement direction of the contact points and the arrangement direction of the contact portions are substantially parallel to each other has been described. However, a connector may be employed, which is configured such that the inserting and removing direction of a MicroUSB connector is inclined relative to an opposing surface and that the arrangement direction of contact points and the arrangement direction of contact portions are substantially parallel to each other. As illustrated in, e.g., a perspective view of FIG. 27 from the above and a perspective view of FIG. 28 from the below, a connector 72 may be employed, which at a surface 70 of a case body 68 inclined relative to a surface 66 at which a protective case 64 is disposed, includes a receiver 62 configured to receive a MicroUSB connector.

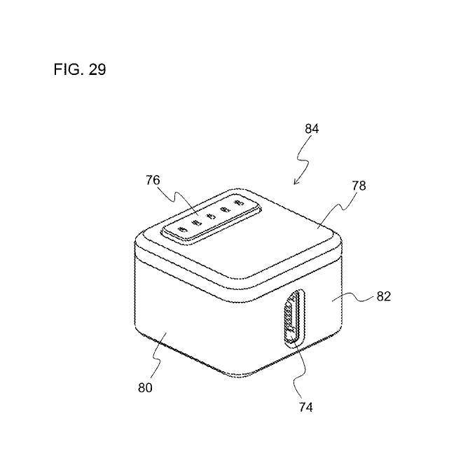

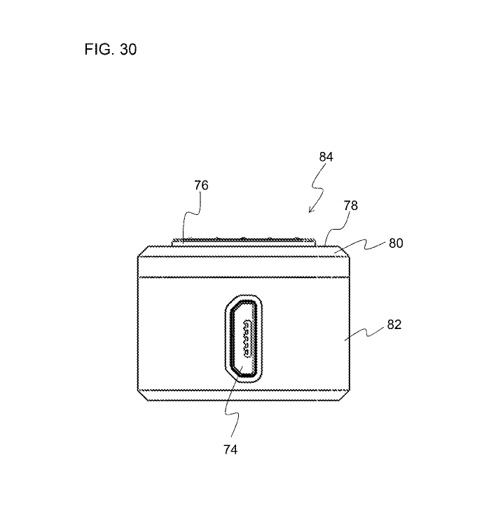

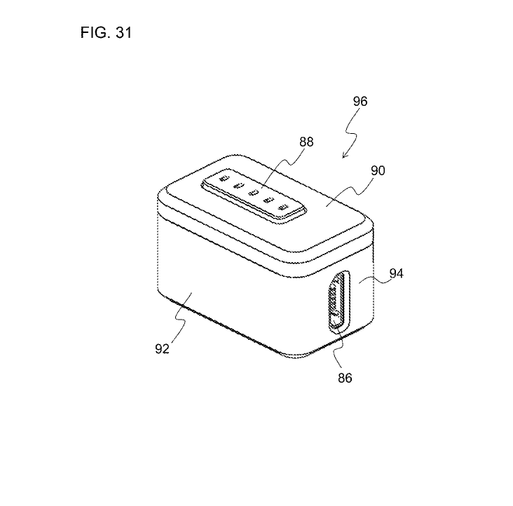

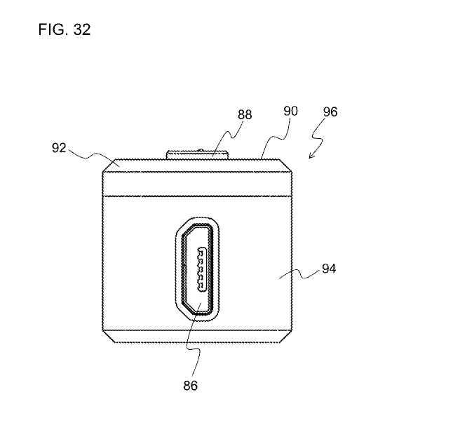

A connector may be employed, which is configured such that the inserting and removing direction of a MicroUSB connector is substantially parallel to an opposing surface and that the arrangement direction of contact points and the arrangement direction of contact portions are substantially perpendicular to each other. As in, e.g., a perspective view of FIG. 29 from the above and a plan view of FIG. 30, a connector 84 may be employed, which includes a receiver 74 configured to receive a MicroUSB connector, at a surface 82 of a case body 80 perpendicular to a surface 78 at which a protective case 76 is disposed. Alternatively, as in, e.g., a perspective view of FIG. 31 from the above and a side view of FIG. 32, a connector 96 may be employed, which at a surface 94 of a case body 92 perpendicular to a surface 90 at which a protective case 88 is disposed, includes a receiver 86 configured to receive a MicroUSB connector.

A connector may be employed, which is configured such that the inserting and removing direction of a MicroUSB connector is substantially perpendicular to an opposing surface and that the arrangement direction of contact points and the arrangement direction of contact portions are substantially perpendicular to each other. Alternatively, a connector may be employed, which is configured such that the inserting and removing direction of a MicroUSB connector is inclined relative to an opposing surface and that the arrangement direction of contact points and the arrangement direction of contact portions are substantially perpendicular to each other.

In each of the above-described embodiments, the MicroUSB connector has been described as an example of a connector for external connection. However, other connector such as a USBType-C connector or a USB3.1 connector may be used as the connector for external connection.

In each of the above-described embodiments, the connector including the magnets as the fixing portions has been described as an example. However, a connector may be employed, which includes, e.g., a mechanical lock with a claw instead of a magnet. In this case, the mechanical lock is also preferably provided at a lower case having a holder (a holding surface) in order to prevent separation of upper and lower cases.

The above-described embodiments have been described for the sake of ease of understanding of the present invention, and are not intended to limit the scope of the present invention. Thus, each element disclosed in the above-described embodiments includes all design changes and equivalents falling within the technical scope of the present invention.

1. A connector comprising:
a case having an opposing surface facing external device; and
a flat plate-shaped contact built in the case,
wherein the case includes
a first opening which is formed at the opposing surface and through which a contact point of the contact to be connected to a connection terminal of the external device protrudes from the opposing surface,
a receiver configured to receive a connector for external connection, and
a holder configured to hold the contact, and
the contact includes
the contact point which is disposed in the first opening and which is to contact with the connection terminal of the external device,
an elastic portion which is disposed in the case and which moves the contact point in a substantially perpendicular direction relative to the opposing surface,
a contact portion which is disposed in the receiver and which is to contact with a connection terminal of the connector for external connection,
a held portion which is formed between the elastic portion and the contact portion and which is held by the holder in the case, and
a connection portion which is formed between the elastic portion and the contact portion and which connects between the contact point and the contact portion in the case.

2. The connector according to claim 1, wherein the case includes a case body having the receiver and the holder, and a protective case having the opposing surface formed with the first opening,
the case body includes a second opening for attachment of the protective case at a surface of the case body facing the external device, and
the protective case is attached to the second opening of the case body to move in the substantially perpendicular direction relative to the opposing surface.

3. The connector according to claim 1, wherein the holder has a holding surface which holds the held portion of the contact and which is substantially parallel to the opposing surface.

4. The connector according to claim 1, further comprising:
the plurality of contacts, wherein
the case includes the at least one first opening through which each of the contact points included by each of the contacts protrudes from the opposing surface.

5. The connector according to claim 4, wherein the connection portion includes a pitch changer configured to, when an arrangement pitch of the contact points of the contacts and an arrangement pitch of contact portions of the contacts are different from each other, change the arrangement pitch of the contact points of the contacts.

6. The connector according to claim 4, wherein the connection portion includes an arrangement order changer configured to, when an arrangement order of the contact points of the contacts and an arrangement order of the contact portions of the contacts are different from each other, change the arrangement order of the contact points of the contacts.

7. The connector according to claim 4, wherein the contacts include first and second contacts forming a differential pair, and
the first and second contacts are configured such that a length of the first contact from a contact point to a contact portion is identical to a length of the second contact from a contact point to a contact portion.

8. The connector according to claim 7, wherein the first and second contacts are formed in a planar or three-dimensional shape.

9. The connector according to claim 7, wherein the first and second contacts are arranged such that a middle position of a line connecting between the contact point of the first contact and the contact point of the second contact and a middle position of a line connecting between the contact portion of the first contact and the contact portion of the second contact are on a line extending perpendicular to an arrangement direction of the contact points and an arrangement direction of the contact portions.

10. The connector according to claim 1, wherein the connector for external connection is a MicroUSB connector, a USBType-C connector, or a USB3.1 connector.

11. The connector according to claim 1, wherein an inserting and removing direction of the connector for external connection is a substantially parallel direction relative to the opposing surface direction, a substantially perpendicular direction relative to the opposing surface, or a direction inclined relative to the opposing surface, and
an arrangement direction of the contact points and an arrangement direction of the contact portions are substantially parallel to each other.

12. The connector according to claim 1, wherein an inserting and removing direction of the connector for external connection is a substantially parallel direction relative to the opposing surface direction, a substantially perpendicular direction relative to the opposing surface, or a direction inclined relative to the opposing surface, and
an arrangement direction of the contact points and an arrangement direction of the contact portions are substantially perpendicular to each other.

13. The connector according to claim 1, further comprising:
a fixing portion configured to, while the contact point is connected to the connection terminal of the external device, fix the external device on the case.

14. The connector according to claim 13, wherein the case includes a first case having a surface facing the external device and a second case having the holder,
the first and second cases are connected together in a direction facing the external device, and
the fixing portion is provided at the second case.

15. The connector according to claim 1, further comprising:
a first shell which is inserted into the case and which has, at a surface facing the external device, a connecting portion to be connected to the external device; and
a second shell which is formed in the receiver and which contacts the first shell,
wherein the first shell is in such a shape that the first shell covers at least the elastic portion and the held portion.
